(19) United States
(12) Patent Application Publication
(10) Pub. No.: US 2016/0316336 A1
(43) Pub. Date: Oct. 27, 2016

(54) WIDEBAND TRANSMITTER FOR POSITION TRACKING SYSTEM IN COMBINED VIRTUAL AND PHYSICAL ENVIRONMENT

(71) Applicant: The Void, LLC, Pleasant Grove, UT (US)

(72) Inventors: Justin Krenz, Pleasant Grove, UT (US); James Jenson, North American, UT (US)

(73) Assignee: The Void, LLC, Pleasant Grove, UT (US)

(21) Appl. No.: 15/068,567

(22) Filed: Mar. 12, 2016

Related U.S. Application Data
(63) Continuation-in-part of application No. 14/942,878, filed on Nov. 16, 2015.
(60) Provisional application No. 62/080,308, filed on Nov. 15, 2014.
(60) Provisional application No. 62/080,307, filed on Nov. 15, 2014.

(51) Int. Cl. H04W 4/02; G01S 5/02; G06T 19/00; H04B 17/27

(52) U.S. Cl. CPC H04W 4/023; H04B 17/27; H04W 4/028; G01S 5/021; G06T 19/006

(57) ABSTRACT

A positional tracking system used in a virtual reality environment in which multiple users may freely and unrestrictedly explore an environment without affecting position tracking. Receivers mounted to the user in several locations may be accurately tracked regardless of the position of the user and other users in the system. A plurality of transmitters may transmit wide band signals to one or more receivers on a user. Each receiver may receive the wide band signals from the plurality of transmitters, process those signals, and determine a receiver location based on the received signals. The signals themselves may be wide band signals, for example in the range of 3 GHz to 10 GHz. The wide band signals may include identifier information and a pulse for determining a time-of-flight between the transmitter and receiver.

### CROSS-REFERENCE TO RELATED APPLICATIONS

This application is a continuation in part and claims the priority benefit of U.S. patent application Ser. No. 14/942,878, titled “Combined Virtual and Physical Environment,” filed Nov. 15, 2015, which claims the priority benefit of U.S. provisional application 62/080,308, titled “Systems and Methods for Creating Combined Virtual and Physical Environments,” filed November 15, 2014, and U.S. provisional application 62/080,307, titled “Systems and Methods for Creating Combined Virtual and Physical Environments,” filed Nov. 15, 2014, the disclosures of which are incorporated herein by reference.

This application is related to U.S. patent application Ser. No. 16/xxx,xxx, titled “Wideband Receiver for Position Tracking System in Combined Virtual and Physical Environment,” filed Jan. XX, 2016, the disclosure of which is incorporated herein by reference

### BACKGROUND OF THE INVENTION

Virtual reality technology is becoming more sophisticated and available to the general public. Currently, many virtual reality systems require a user to sit in a chair, wear a bulky headset, and face a specific direction while limited optical sensors track certain movements of portions of the headset. As a user moves his head from side to side, an image provided to a user may change. The optical sensors provide a line-of-sight signal to a headset and may provide input to a remote server to update a graphical interface when the headset is detected to shift to the left or the right.

Virtual reality systems based on optical tracking have significant limitations. First, virtual-reality tracking systems based on optical sensors require a line of sight between the optical sensor and the user. If at any time something gets between the user and the optical sensor, such as a wall or another user, or even a part of the user's body if the user turns his or her back on the sensor, the optical sensor will fail to be detected and errors will occur in the virtual reality display. This is not a problem, typically, for virtual-reality systems in which a user sits in a chair and looks directly at optical sensors without any intervening objects. However, virtual-reality systems using optical sensors do not work for users where intervening objects may interrupt a line of sight between the sensor and the user, such as a virtual reality system where other users may be present. What is needed is an improved position tracking system for virtual-reality system.

### SUMMARY OF THE CLAIMED INVENTION

The present technology, roughly described, provides a positional tracking system for use in the virtual reality environment in which multiple users may freely and unrestrictedly explore an environment without affecting position tracking. Receivers mounted to the user in several locations may be accurately tracked regardless of the position of the user and other users in the system. A plurality of transmitters may transmit wide band signals to one or more receivers on a user. Each receiver may receive the wide band signals from the plurality of transmitters, process those signals, and determine a receiver location based on the received signals. The signals themselves may be wide band signals, for example in the range of 3 GHz to 10 GHz. The wide band signals may include identifier information and a pulse for determining a time-of-flight between the transmitter and receiver.

The transmitter signals can be sent from a synchronized wideband driven clock to the one or more receivers. Receivers may determine the time-of-flight information for each identified transmitter, determining the position of each receiver, and provide that information to a computing device. The computing device may determine the receiver location and provide that location information to a virtual reality engine. Virtual reality engine may update the user's perspective and other display and audio components within the virtual reality environment based on updated positional data.

In an embodiment, a method may transmit a plurality of wide band tracking signals within a position tracking system. The method may begin with serially transmitting portions of a transmitter identifier for each transmitter by each transmitter of a plurality of transmitters in serial format. The transmitters may be located within a pod, and the pod may include one or wide band receivers. A wide band pulse may be transmitted from the first transmitter of the plurality of transmitters. A wide band pulse may be transmitted from each of the remaining plurality of transmitters. The serial transmission of the wideband pulses from each of the plurality of transmitters may be repeated until a minimum number of transmissions required for sub-sampling processing by a receiver have been sent by each transmitter.

In an embodiment, a system for transmitting a plurality of wide band tracking signals within a position tracking system may include a plurality of transmitters, and an antenna circuitry for each transmitter. Each transmitter may be configured to transmit a wideband signal. The circuitry may serially transmit portions of a transmitter identifier for each transmitter through the antenna as a wideband signal, the transmitters located within a pod, the pod including one or wide band receivers. The circuitry may also generate a wide band pulse and transmit the wide-band pulse serially through an antenna of each transmitter. The circuitry may further repeat the serial transmission of the wideband pulses from each of the plurality of transmitters until a minimum number of transmissions required for sub-sampling processing by a receiver have been sent by each transmitter.

### BRIEF DESCRIPTION OF THE DRAWINGS

FIG. 1 is a block diagram of a virtual reality system with a wideband based position tracking system.

FIG. 2 is an illustration of a plurality of transmitters within a pod.

FIG. 3 is a block diagram of a transmitter.

FIG. 4 is a method for performing position tracking within a virtual reality system.

FIG. 5 is a method of calibrating a position tracking system.

FIG. 6 is a method for transmitting a wideband signal by a plurality of transmitters in a virtual reality system.

FIG. 7 is a block diagram of a computing device for use with the present technology.

### DETAILED DESCRIPTION

The present technology, roughly described, provides a positional tracking system for use in the virtual reality environment in which multiple users may freely and unrestrictedly explore an environment without affecting position tracking for each of the users. Receivers mounted to the user (i.e., players in the virtual reality system) in several locations may be accurately tracked regardless of the position of the user and other users in the system. A plurality of transmitters may transmit wide band signals to one or more receivers on a user. Each receiver may receive the wide band signals from the plurality of transmitters, process those signals, and determine a receiver location based on the received signals. The signals themselves may be wide band signals, for example in the range of 3 GHz to 10 GHz. The wide band signals may include identifier information and a pulse for determining a time-of-flight between the transmitter and receiver.

The transmitter signals can be sent from a synchronized wideband driven clock to the one or more receivers. Receivers may determine the time-of-flight information for each identified transmitter, determining the position of each receiver, and provide that information to a computing device. The computing device may determine the receiver location and provide that location information to a virtual reality engine. A virtual reality engine may update the user's perspective and other display and audio components within the virtual reality environment based on updated positional data.

The wide band signal transmitting system may be implemented as a series of components and circuitry, as an integrated circuit (IC) that controls and transmits wideband signals, or in some other form. When implemented as an IC, the wideband transmitter system may implement the functionality and features discussed herein while including modifications known in the art for implementing such features in small scale devices.

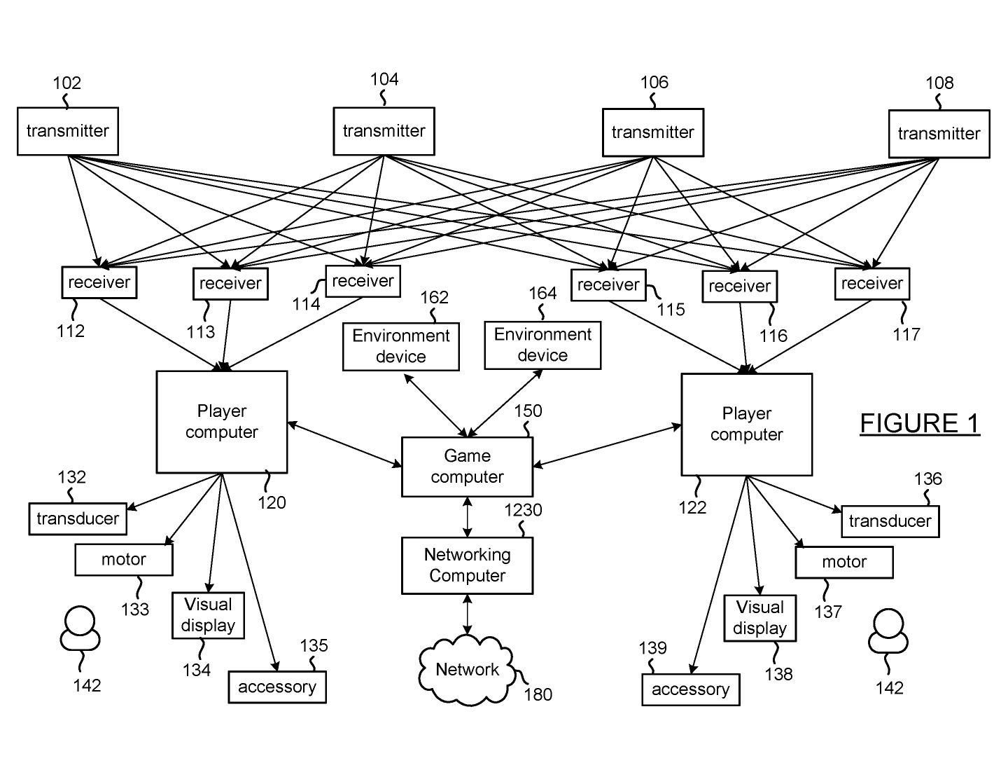

FIG. 1 is a block diagram of a virtual reality system with a wideband based position tracking system. The system of FIG. 1 includes transmitters 102, 104, 106, and 108, receivers 112, 113, 114, 115, 116 and 117, player computers 120 and 122, transducers 132 and 136, motors 133 and 137, virtual display 134 and 138, accessories 135 and 139, players 140 and 142, game computer 150, environment devices 162 and 164, networking computer 170, and network 180.

Receivers 112-117 may be placed on a player 140 or an accessory 135. Each receiver may receive one or more signals from one or more of transmitters 102-108. The signals received from each transmitter may include an identifier to identify the particular transmitter. In some instances, each transmitter may transmit an omnidirectional signal periodically at the same point in time. Each receiver may receive signals from multiple transmitters, and each receiver may then provide signal identification information and timestamp information for each received signal to player computer 120. By determining when each transmitter signal is received from a receiver, player computer 120 may identify the location of each receiver.

Player computer 120 may be positioned on a player, such as for example on the back of a vest worn by a player. A player computer may receive information from a plurality of receivers, determine the location of each receiver, and then locally update a virtual environment accordingly. Updates to the virtual environment may include a player's point of view in the environment, events that occur in the environment, and video and audio output to provide to a player representing the player's point of view in the environment along with the events that occur in the environment.

Player computer 120 may also communicate changes to the virtual environment determined locally at the computer to other player computers, such as player computer 122, through game computer 150. In particular, a player computer for a first player may detect a change in the player's position based on receivers on the player's body, determine changes to the virtual environment for that player, provide those changes to game computer 150, and game computer 150 will provide those updates to any other player computers for other players in the same virtual reality session, such as a player associated player computer 122.

A player 140 may have multiple receivers on his or her body. The receivers receive information from the transmitters 102-108 and provide that information to the player computer. In some instances, each receiver may provide the data to the player computer wirelessly, such as for example through a radiofrequency signal such as a Bluetooth signal. In some instances, each receive may be paired or otherwise configured to only communicate data with a particular players computer. In some instances, a particular player computer may be configured to only receive data from a particular set of receivers. Based on physical environment events such as a player walking, local virtual events that are provided by the players computer, or remote virtual events triggered by an element of the virtual environment located remotely from the player, haptic feedback may be triggered and sensed by a player. The haptic feedback may be provided in the terms of transducer 132 and motor 133. For example, if an animal or object touches a player at a particular location on the player's body within the virtual environment, a transducer located at that position may be activated to provide a haptic sensation of being touched by that object.

Visual display 134 may be provided through a headset worn by player 140. The virtual display 134 may include a helmet, virtual display, and other elements and components needed to provide a visual and audio output to player 140. In some instances, player computer 120 may generate and provide virtual environment graphics to a player through the virtual display 140.

Accessory 135 may be an element separate from the player, in communication with player computer 120, and displayed within the virtual environment through visual display 134. For example, an accessory may include a gun, a torch, a light saber, a wand, or any other object that can be graphically displayed within the virtual environment and physically engaged or interacted with by player 140. Accessories 135 may be held by a player 140, touched by a player 140, or otherwise engaged in a physical environment and represented within the virtual environment by player computer 120 through visual display 134.

Game computer 150 may communicate with player computers 120 and 122 to receive updated virtual information from the player computers and provide that information to other player computers currently active in the virtual reality session. Game computer 150 may store and execute a virtual reality engine, such as Unity game engine, Leap Motion, Unreal game engine, or another virtual reality engine. Game computer 150 may also provide virtual environment data to networking computer 170 and ultimately to other remote locations through network 180.

Environment devices 162 may include physical devices that form part of the physical environment. The devices 162 may provide an output that may be sensed or detected by a player 140. For example, an environment device 162 may be a source of heat, cold, wind, sound, smell, vibration, or some other sense that may be detected by a player 140.

Transmitters 102-108 may transmit a synchronized wideband signal within a pod to one or more receivers 112-117. Logic on the receiver and on a player computing device, such as player computing device 120 or 122, may enable the location of each receiver to be determined in a universal space within the pod.

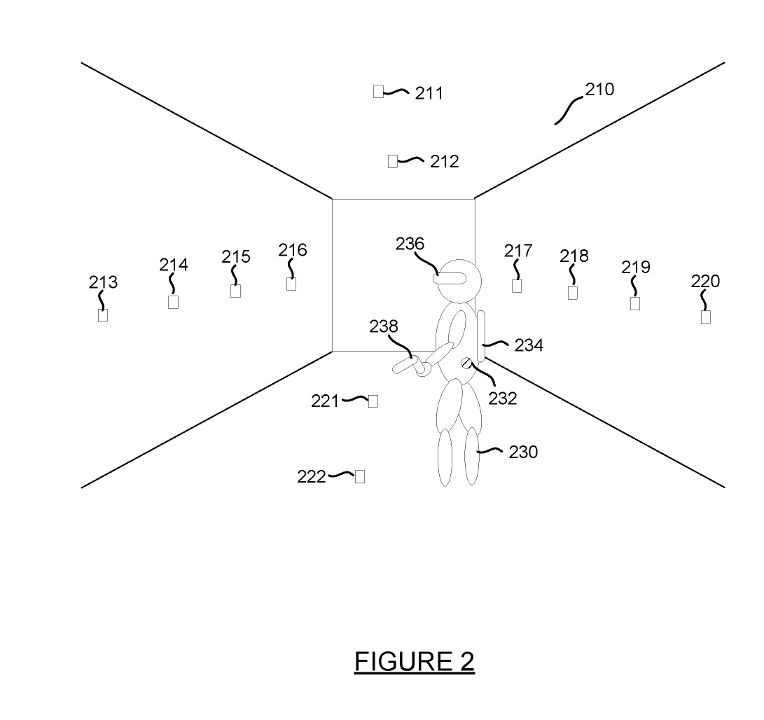

FIG. 2 is an illustration of a plurality of transmitters within a pod. FIG. 2 includes pod 210, transmitters 211 and 212 located in a ceiling of the pod, transmitters 213-216 located on a first wall of the pod, transmitters 217-220 located on a second wall of the pod, and transmitters 221 and 222 located in the floor of the pod. The location of the transmitters are exemplary, and a transmitter may be placed in any location within a pod, such as a ceiling, wall, floor, object, or some other location. In some implementations, each transmitter may be an approximate distance from another transmitter to ensure transmitter signals are received by each receiver. For example, in some implementations, each transmitter may be positioned no more than approximately ten feet from another transmitter. Each transmitter may transmit a wideband signal within pod 210. The signal may include an identifier and a pulse. The transmitter signals may be driven from the same clock, derived from a single source or controller (not illustrated in FIG. 2). In some implementations, the signals can be sent in an interleaved fashion, such that portions of an identifier are sent serially, by one transmitter at a time in turn, and then pulses are sent serially, by one transmitter at a time.

User 230 may be configured with one or more receivers 232, a computing device 234, a head mount unit 236, and one or more accessories 238. Each receiver 232 may receive a signal from a plurality of transmitters 211-222. The receivers may receive a wideband pulse, process the pulse, and determine the location of the receiver based on a time-of-flight of the pulse and transmitter identification information also transmitted by the transmitter.

Once the receiver position is known, the receiver location is provided to computing device 234 to update a virtual reality environment based on receiver positions. A virtual reality engine may be hosted on computing device 234, and may provide a graphic update to the user through unit 236 which is in communication with computing device 234. In addition to determining the position of one or more receivers associated with parts of the user's body, positions of an accessory 238 may be determined by one or more receivers positioned on the accessory.

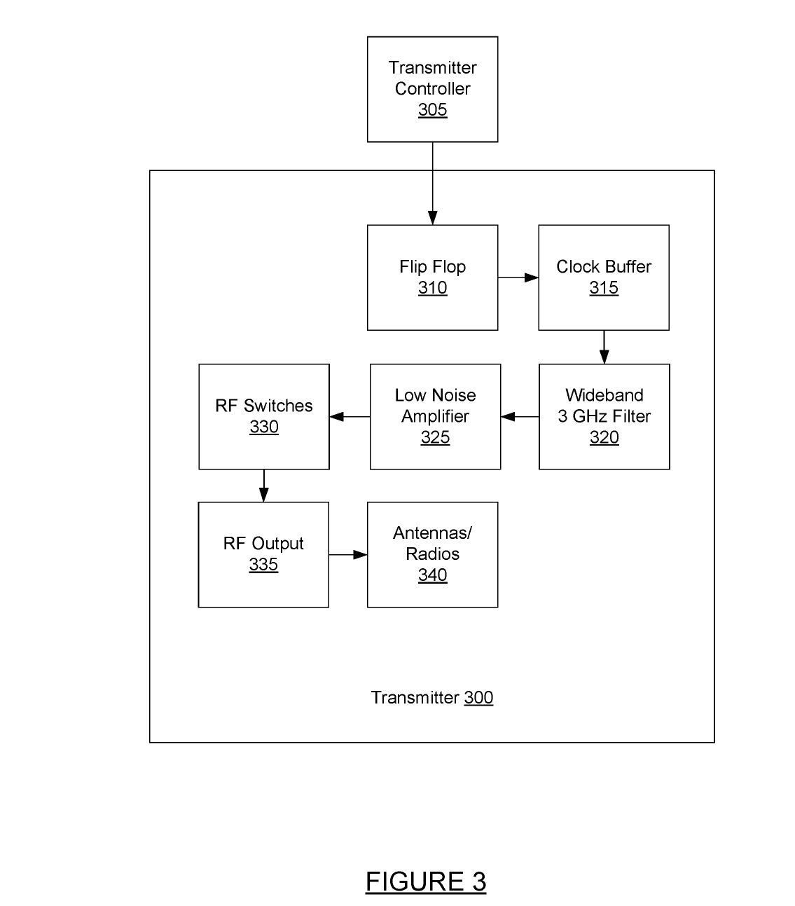

FIG. 3 is a block diagram of a transmitter 300. Transmitter 300 may provide more detail for the transmitter of FIG. 2. Transmitter 300 includes flip-flop 310, clock buffer 315, wideband filter 320, amplifier 325, RF switches 330, RF output 335, and antenna 340. In some implementations, one or more of the transmitter portions 310-340, or similar portions that perform the same functionality, may be implemented as one or more of individual components, circuitry, and logic. In some implementations, the transmitter portions 310-340 or similar portions that perform the same functionality, may be implemented in whole or in part on one or more integrated circuits.

Controller 305 may provide signals to control multiple transmitters 300. For each transmitter, the controller may provide a clock signal, enable signal, and an antenna select signal, if multiple antennas are available to transmit from transmitter 300. In some instances, a controller may only enable a subset of the total available transmitters to transmit a wideband signal. For example, the users within a pod may have a location known to controller 305. As such, controller 305, which knows the position of each transmitter, may only select those transmitters in close proximity to the known user location as a transmitters to transmit a signal. In some instances, the controller may choose a minimum number of transmitters near a particular user, such as for example four transmitters, to ensure enough pulses reach a receiver to enable its location to be determined.

Controller 305 may provide the same clock signal to each transmitter. Providing the same clock signal to each transmitter allows for synchronized transmissions by the transmitters, which in turn assist the receivers to determine the respective locations based on the transmitter wideband signals. In some instances, the clock provided by the controller is a stable clock, and will not trip based on temperature or other causes. For example, the clock may utilize an oven oscillator which is stable at a raised temperature maintained by a heating element of the oscillator.

In operation, flip-flop 310 receives a clock signal and enable signal from transmitter controller 305. Flip-flop 310 may turn a square edge provided by the clock into a sharp edge pulse, such that every pulse output by the transmitter will be similar and similarly sharp. The output pulse of flip-flop 310 may be provided to clock buffer 315. Clock buffer 315 may be a high-frequency clock buffer, such as for example a 7 GHz clock buffer. The output of the high-frequency clock buffer may be provided to wideband filter 320. The wideband filter may turn the pulse into a 3 GHz signal, and can be implemented as a 7 GHz filter. The resulting signal output by the wideband filter, for example an output 7 GHz output signal, is provided to the low noise amplifier 325. A clean 3 GHz signal with little or no low-frequency noise is then provided to RF switch 330. In a case where a transmitter 300 has multiple antennas for sending signals, RF switch 330 may select the particular antenna over which to transmit the signal. In some instances, the particular antenna may be selected by controller 305. The signal is sent from a switch to the RF output element 335 and then finally broadcast into the pod space by antenna 340. The output signal will have a wavelength of around 250 to 300 ps.

Transmitter 300 of FIG. 3 is just one example of a transmitter implementation. Other implementations are possible. For example, transmitter may be implemented as a series of integrated circuits and other circuitry, as a single integrated IC, or in some other form.

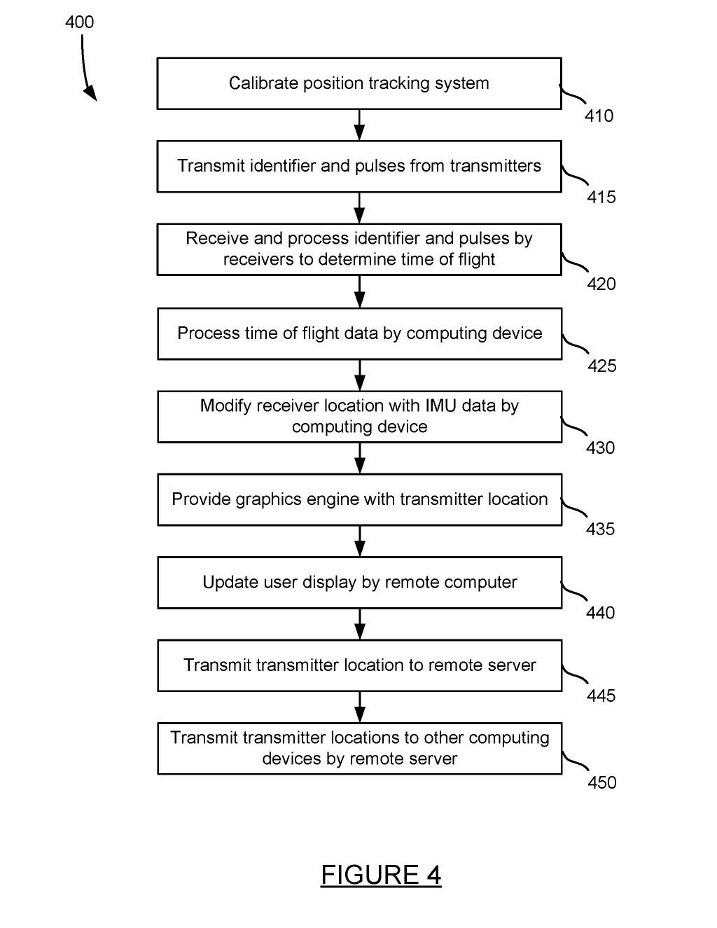

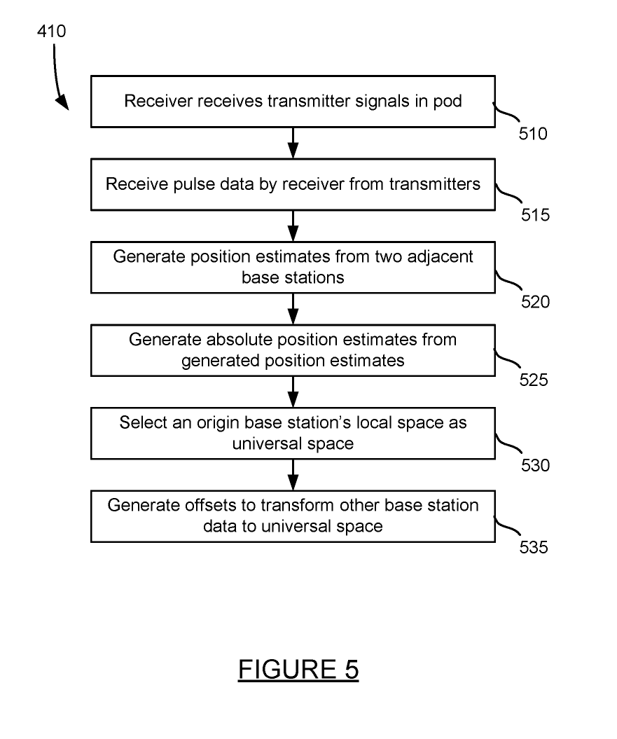

FIG. 4 is a method for performing position tracking in a virtual reality system. First, a position tracking system may be calibrated at step 410. The calibration may involve setting the relative positions of the transmitters with respect to each other within a universal space defined within the pod. Calibrating a position tracking system is discussed in more detail below with respect to the method of FIG. 5.

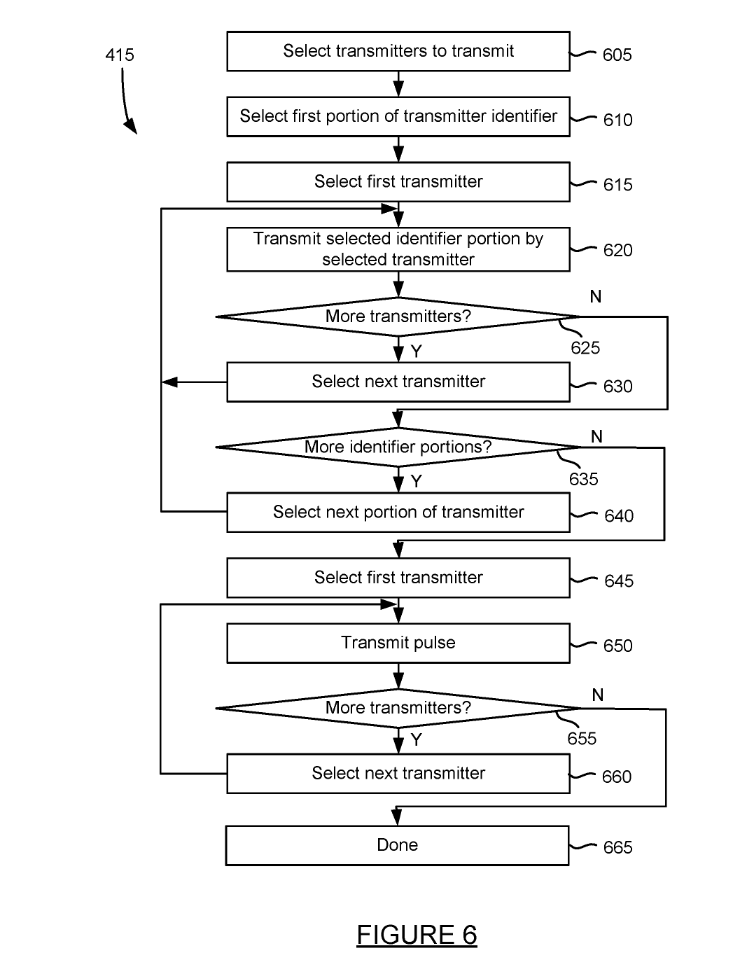

Identifiers and pulses are transmitted from position tracking transmitters at step 415. In some instances, the identifiers and pulses may be sent serially in turn by multiple transmitters, and in portions rather than as entire and complete sets of information. The pulses and identifiers are sent as wideband signals from transmitters driven by the same clock source. More detail for transmitting identifiers impulses from position tracking transmitters is discussed with respect to the method of FIG. 6.

The identifiers and pulses are received and processed by receivers of the position tracking system at step 420. The processing may include determining a time-of-flight of each pulse as well as the identification of the transmitter that sent each pulse. Receiving and processing identifiers and pulses from receivers in a position tracking system is discussed in more detail below with respect to the method of FIG. 9.

Time-of-flight data is provided to a computing device at step 425. In some instances, each receiver may receive wideband signals from multiple transmitters, determine time-of-flight data for each pulse received by a particular transmitter, and provide the time of flight data to the computing device. A computing device may process the time-of-flight data to identify the position of the receiver.

In some instances, the time-of-flight for each transmitter may be used to create a sphere around the transmitter. When four spheres are generated in a model space using time of flight data, a location of the intersection of all for spheres may correspond to a position of the receiver that received the four pulses with the corresponding time of flights used to create those spheres. A computing device may process a time-of-flight data by creating spheres having a radius of the time-of-flight for each transmitter to determine the location of a particular receiver that provided the time-of-flight data to the computing device.

A computing device may compare an updated location of the receiver to determine if a change in position is greater than a threshold value at step 430. If the receiver location appears to change greater than a threshold amount, a computing device may access data from an inertial movement unit to confirm the change in position or to modify the change in position. The inertial movement unit (IMU) may include an accelerometer or other circuits or hardware to detect movement. When the IMU was placed on a user, such as for example the user's head, or elsewhere on the body of the user, a change detected by the IMU may be used to confirm the change in position detected based on time-of-flight data or dampen the change based on detecting movement by the IMU unit.

A graphics engine may be provided with the transmitter location at step 435. Once a computing device has determined the receiver location and modify the receiver location as necessary, the location may be provided to a virtual reality engine for updating the user's virtual position within the virtual environment. Once the user's virtual position has been updated, a user display may be updated by the remote computer at step 440. User display will be updated to show a new perspective within the virtual environment based on the user's movement. The transmitter location may be sent to a remote server at step 445. With reference to FIG. 1, player computing device 122 may send receiver location to game computer 1230 which in turn transmits receiver location to other computing devices such as player computer 120 at step 450.

FIG. 5 is a method for calibrating a position tracking system. The method of FIG. 5 provides more detail for step 410 the method of FIG. 4. First, a receiver receives transmitter signals within a pod at step 510. In some instances, the receiver may be moved through the pod, for example automatically or by an administrator. In some instances, rather than moving a receiver through a pod, receivers may be set within the pod space at certain locations with a known distance from certain transmitters.

Pulse data may be received by the receiver from multiple transmitters at step 515. In some instances, the pulses should be received from at least two transmitters, wherein the distance between the transmitters and the relative location of the receiver is known.

Position estimates may be generated from two adjacent base stations at step 520. The position estimates may be generated using a three-dimensional modeling techniques to generate the estimates. As part of determining estimates, a system may determine positional offsets and rotational offsets. Positional offsets may be determined by subtracting one position estimate from another position estimate. Rotational offsets may be determined by obtaining three positional estimates, generating a model triangle, and calculating the three-dimensional rotation of the triangle in each base stations local space. From the positional offsets and rotational offsets, a rotational matrix can be obtained that describes how to rotationally transform a position between adjacent base stations. One or more of the rotational matrix, positional offsets, and rotational offsets may be used to determine the location of each transmitter.

An origin base station's local space is selected as the universal space at step 530. Offsets may then be generated to transform other base station coordinates to the universal space at step 535. The coordinates of each base station (e.g., transmitter) are stored with transmitter identifier information and used to identify a position of a receiver that receives pulse data from the transmitters.

FIG. 6 is a method for transmitting wideband data from a plurality of transmitters within a virtual reality position tracking system. Method of FIG. 6 provides more detail for step 415 of the method of FIG. 4.

First, transmitters are selected to transmit a wideband signal at step 605. In some instances, less than all the transmitters in a pod may transmit a pulse within the pod. A transmitter controller may have information regarding the location of one or more receivers. The information may include receiver locations within the pod, the location of a user and corresponding receivers attached to the user, or other receiver location information. With location information for one or more receivers, and knowledge of where each transmitter is within the pod, the transmitter controller may select transmitters that are positioned closest to the receivers to transmit a wideband signal to those receivers. In some instances, the nearest four transmitters may be selected to transmit to a particular receiver. The group of transmitters selected to transmit to a first receiver or set of receivers (e.g., a receiver group located on a user) may include one or more transmitters to transmit to a second receiver or set of receivers. Hence, the selected transmitters selected to transmit for each receiver of a plurality of receivers may have overlapping transmitters.

In some implementations, a transmitter may transmit a plurality of pulses followed by a transmitter identifier. Both the pulses and identifier may be sent in a serial format, wherein each transmitter sends out a signal by itself, when no other transmitter is transmitting any other signal. After the current transmitter transmits its signal, the next transmitter sends out a wideband signal. The process can continue in a serial fashion, so that each transmitter sends out a signal one at a time and in turn, until each transmitter has sent out a wideband signal. Once all transmitters have transmitted, the process repeats for additional transmissions. In some implementations, each transmitter transmits a transmitter identifier and a plurality of pulses before another transmitter transmits a transmitter identifier and a plurality of pulses. Variations on the order of pulses and transmission identifier, and interleaving the transmissions from multiple transmitters, are within the scope of the present technology.

With respect to the identifier portion of a wideband signal, each transmitter may send out a portion of its identifying information serially and in turn. Hence, first, a first portion of a transmitter identifier is selected at step 610. In some instances, a transmitter identifier may include a preamble, a sync word, and the identifier itself. The first portion may include the preamble, which may consist of an “on” pulse or high signal. Once the first portion of the transmitter identifier is selected, the first transmitter to transmit a signal is selected at step 615 and the selected identifier portion is transmitted by the selected identifier at step 620. After the first transmission by the first transmitter, a determination is made as to whether any more transmitters exist in the group of transmitters at step 625. If more transmitters exist, the next transmitter is selected at statement 30 and the method returns to step 620. If no more transmitters exist, then the method continues to step 635.

A determination is made as to whether there are more identifier portions to send at step 635. If there are no further identifier portions to transmit, the method of FIG. 6 continues to step 645. If more identifier portions exist to be sent, the next portion is selected at step 640 and the method of FIG. 6 returns to step 620. The additional portions of the identifier may include one or more portions of a sync word and one or more portions of the transmitter identifier.

At step 645, a first transmitter is selected and a pulse is transmitted by the first transmitter at step 650. The transmitted pulse is received by a receiver and processed to determine a time-of-flight between the transmitter and receiver, and ultimately determine the location of the receiver. A determination is made at step 655 as to whether there are more transmitters to transmit a pulse from. If more transmitters exist, the next transmitter in the selected group of transmitters is selected at step 660 and the method of FIG. 6 continues to step 650 were the selected transmitter transmits a pulse. If there are no more transmitters to select a pulse, the method of FIG. 6 may be complete at step 665.

In some instances, steps 645 through 660 may repeat for a minimum number of pulses in order for subsampling to be performed at the receiver. The sub-sampling is used to collect enough information to accurately sample the transmitted pulse. For example, the number of pulses needed to allow a receiver to perform subsampling on a 3 GHz pulse may be 300 pulses.

In some implementations, each transmitter transmits a number of pulses before another transmitter transmits any pulses, rather than transmitting pulses in a serially rotating fashion.

In some embodiments, a comparator may be used to help determine when a pulse has been received. In particular, the RF input can be connected to a comparator with a DAC output also connected in order to create a high frequency successive approximation ADC. During a preamble sequence of “on” pulses, the output of the successive approximation ADC can be used to control a variable attenuator to ensure the incoming pulses do not exceed the analog to digital converter's input voltage range. The comparators output will be at a logic high when a pulse was received within a previous time period, such as for as for example three nanoseconds (ns). If the comparators output is low, this indicates that no pulse has been received in the previous time period.

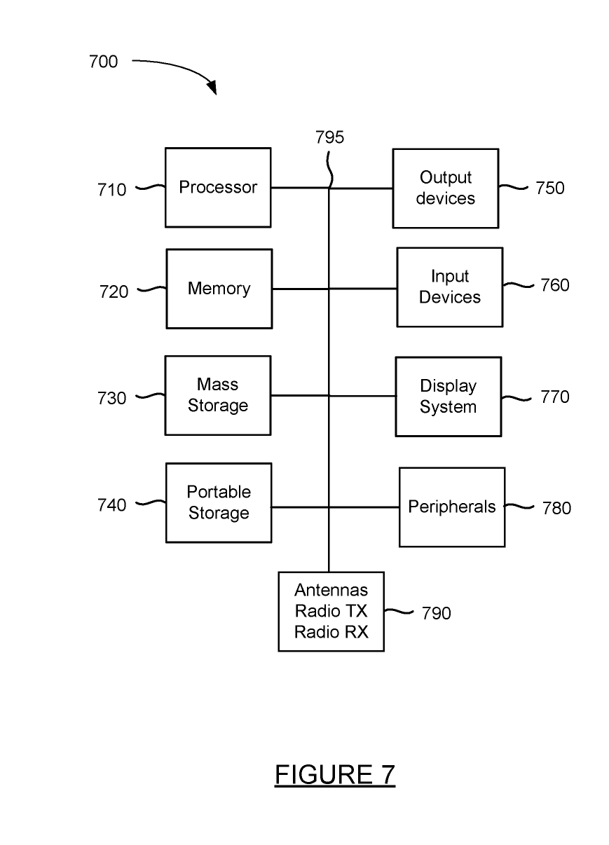

FIG. 7 illustrates an exemplary computing system 700 that may be used to implement a computing device for use with the present technology. System 700 of FIG. 7 may be implemented in the contexts of the likes of player computing devices 120 and 122 and game computer 150. The computing system 700 of FIG. 7 includes one or more processors 710 and memory 710. Main memory 710 stores, in part, instructions and data for execution by processor 710. Main memory 710 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 710 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive, an optical disk drive, or solid state non-volatile storage, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for transmitting a plurality of wide band tracking signals within a position tracking system, the method comprising:
serially transmitting portions of a transmitter identifier for each transmitter by each transmitter of a plurality of transmitters in serial format, the transmitters located within a pod, the pod including one or wide band receivers;
transmitting a wide band pulse from the first transmitter of the plurality of transmitters; and
transmitting a wide band pulse from each of the remaining plurality of transmitters; and

2. The method of claim 1, wherein transmitting a wide band transmitter identifier and wide band pulse from each of the remaining plurality is done in serial format.

3. The method of claim 1, further comprising:
transmitting a first portion of a transmitter identifier as a wide band signal from a first transmitter of the plurality of transmitters;
transmitting serially a first portion of a transmitter identifier as a wide band signal from each of the remaining transmitters in the plurality of transmitters; and
serially transmitting subsequent portions of the respective transmitter identifiers by each of the plurality of transmitters.

4. The method of claim 1, wherein the wide band signal has a frequency within the range of about 3 to 10 gigahertz

5. The method of claim 1, further comprising selecting a subset of a plurality of transmitters to transmit the wide band pulse.

6. The method of claim 5, further comprising:
determining the location of the one or more receivers;
identifying a minimum number of transmitters that are closest to each of the receivers; and
selecting the identified transmitters as the subset of transmitters to transmit the wide band pulse.

7. The method of claim 1, wherein the identifier includes a preamble, synchronization portion, and a transmitter identifier.

8. The method of claim 1, further including calibrating the plurality of transmitters

9. The method of claim 8, wherein calibration includes:
transmitting a wide band pulse by the plurality of transmitters to a calibration receiver;
generating position estimates from two adjacent base stations;
generating absolute position estimates for the transmitters;
selecting a transmitter of the plurality of transmitters to serve as an origin of space that contains the plurality of transmitters; and
storing spatial offset data for each transmitter based on the absolute position estimates for translating each transmitters location in the space that contains the plurality of transmitters.

10. The method of claim 1, wherein the receivers and the transmitters are part of a virtual reality position tracking system.

11. The method of claim 1, further comprising repeating the serial transmission of the wideband pulses from each of the plurality of transmitters until a minimum number of transmissions required for sub-sampling processing by a receiver have been sent by each transmitter.

12. A non-transitory computer readable storage medium having embodied thereon a program, the program being executable by a processor to perform a method for transmitting a plurality of wide band tracking signals within a position tracking system, the method comprising:
serially transmitting portions of a transmitter identifier for each transmitter by each transmitter of a plurality of transmitters in serial format, the transmitters located within a pod, the pod including one or wide band receivers;
transmitting a wide band pulse from the first transmitter of the plurality of transmitters;
transmitting a wide band pulse from each of the remaining plurality of transmitters; and

13. The non-transitory computer readable storage medium of claim 12, wherein transmitting a wide band transmitter identifier and wide band pulse from each of the remaining plurality is done in serial format.

14. The non-transitory computer readable storage medium of claim 12, further comprising:
transmitting a first portion of a transmitter identifier as a wide band signal from a first transmitter of the plurality of transmitters;
transmitting serially a first portion of a transmitter identifier as a wide band signal from each of the remaining transmitters in the plurality of transmitters; and
serially transmitting subsequent portions of the respective transmitter identifiers by each of the plurality of transmitters.

15. The non-transitory computer readable storage medium of claim 12, wherein the wide band signal has a frequency within the range of about 3 to 10 gigahertz

16. The non-transitory computer readable storage medium of claim 12, further comprising selecting a subset of a plurality of transmitters to transmit the wide band pulse.

17. The non-transitory computer readable storage medium of claim 16, further comprising:
determining the location of the one or more receivers;
identifying a minimum number of transmitters that are closest to each of the receivers; and
selecting the identified transmitters as the subset of transmitters to transmit the wide band pulse.

18. The non-transitory computer readable storage medium of claim 12, wherein the identifier includes a preamble, synchronization portion, and a transmitter identifier.

19. The non-transitory computer readable storage medium of claim 12, further including calibrating the plurality of transmitters.

20. The non-transitory computer readable storage medium of claim 19, wherein calibration includes:
transmitting a wide band pulse by the plurality of transmitters to a calibration receiver;
generating position estimates from two adjacent base stations;
generating absolute position estimates for the transmitters;
selecting a transmitter of the plurality of transmitters to serve as an origin of space that contains the plurality of transmitters; and
storing spatial offset data for each transmitter based on the absolute position estimates for translating each transmitters location in the space that contains the plurality of transmitters.

21. The non-transitory computer readable storage medium of claim 12, wherein the receivers and the transmitters are part of a virtual reality position tracking system.

22. The non-transitory computer readable storage medium of claim 12, the method further comprising repeating the serial transmission of the wideband pulses from each of the plurality of transmitters until a minimum number of transmissions required for sub-sampling processing by a receiver have been sent by each transmitter.

23. A system for transmitting a plurality of wide band tracking signals within a position tracking system, the system comprising:
a plurality of transmitters, each transmitter including an antenna and circuitry;
the antenna for each transmitter configured to transmit a wideband signal;
the circuitry serially transmitting portions of a transmitter identifier for each transmitter through the antenna as a wideband signal, the transmitters located within a pod, the pod including one or wide band receivers;
the circuitry generating a wide band pulse and transmitting the wide-band pulse serially through an antenna of each transmitter;
the circuitry repeating the serial transmission of the wideband pulses from each of the plurality of transmitters until a minimum number of transmissions required for sub-sampling processing by a receiver have been sent by each transmitter.

24. The system of claim 23, wherein transmitting a wide band transmitter identifier and wide band pulse from each of the remaining plurality is done in serial format.

25. The system of claim 23, the circuitry further generating and transmitting over an antenna of each of the plurality of transmitters a first portion of a transmitter identifier as a wide band signal from a first transmitter of the plurality of transmitters, serially transmitting over each of the plurality of transmitters a first portion of a transmitter identifier as a wide band signal from each of the remaining transmitters in the plurality of transmitters, and serially transmitting over each of the plurality of transmitters subsequent portions of the respective transmitter identifiers by each of the plurality of transmitters.

26. The system of claim 23, wherein the wide band signal has a frequency within the range of about 3 to 10 gigahertz

27. The system of claim 23, the circuitry further selecting a subset of a plurality of transmitters to transmit the wide band pulse.

28. The system of claim 27, the circuitry further determining the location of the one or more receivers, identifying a minimum number of transmitters that are closest to each of the receivers, and selecting the identified transmitters as the subset of transmitters to transmit the wide band pulse.

29. The system of claim 23, wherein the identifier includes a preamble, synchronization portion, and a transmitter identifier.

30. The system of claim 23, the circuitry further calibrating the plurality of transmitters

31. The system of claim 30, wherein calibration includes:
transmitting a wide band pulse by the plurality of transmitters to a calibration receiver;
generating position estimates from two adjacent base stations;
generating absolute position estimates for the transmitters;
selecting a transmitter of the plurality of transmitters to serve as an origin of space that contains the plurality of transmitters; and
storing spatial offset data for each transmitter based on the absolute position estimates for translating each transmitters location in the space that contains the plurality of transmitters.

32. The system of claim 23, wherein the receivers and the transmitters are part of a virtual reality position tracking system.
